(19) United States
(12) Patent Application Publication
(10) Pub. No.: US 2005/0172491 A1
(43) Pub. Date: Aug. 11, 2005

(54) Shaving apparatus with spring-mounted shaving head holder

(76) Inventor: Johannes Beugels, Drachten (NL)

Correspondence Address: PHILIPS INTELLECTUAL PROPERTY & STANDARDS, P.O. BOX 3001, BRIARCLIFF MANOR, NY, 10510, US

(21) Appl. No.: 10/513,277

(22) PCT Filed: Apr. 23, 2003
(86) PCT No.: PCT/IB03/01689

(30) Foreign Application Priority Data
May 7, 2002 (EP) 02076825.5

(51) Int. Cl. B26B 19/14

(52) U.S. Cl. 30/43.6

(57) ABSTRACT

Shaving apparatus having a housing (1) and a shaving head holder (2) that is pivotably connected to the housing (1) and can pivot from an open position to a closed position against the force of a spring (8), and having latching means (10-13) for latching the shaving head holder to, and unlatching the shaving head holder from, the housing in a closed position of said holder. To improve the skin contour-following properties during shaving, the shaving head holder (2) in its closed position can be depressed against the force of a spring (8).

The invention relates to a shaving apparatus comprising a housing and a shaving head holder provided with at least one cutting unit comprising an external cutting member with hair-entry apertures and an internal cutting member which can be rotated with respect to said external cutting member, which shaving head holder is connected to the housing so as to be pivotable about a pivot pin, and can be pivoted from a first position, wherein the shaving head holder is in an open position with respect to the housing, against the action of a spring, to a second position wherein the shaving head holder is in a closed position with respect to the housing, and latching means are present to latch the shaving head holder in the second position on the housing or to unlatch it from said housing.

Such a shaving apparatus is known from U.S. Pat. No. 4,318,223. It is known that in order to make shaving easier the shaving head holder and/or the cutting units, also referred to as shaving heads, can be embodied so as to be slightly floating and/or tiltable with respect to the housing of the shaving apparatus which also forms the handle. By virtue thereof, the shaving surface that is formed by the outside surface of the external cutting members can follow the contours of the facial surface more readily. As a result, to shave facial surfaces that are more difficult to reach, such as under the skin, the user does not have to make many additional movements of the wrist to reach said facial surfaces with the shaving head(s). Such shaving apparatus thus follow the contours of the face. Shaving apparatus with a tiltable shaving head holder are known, for example, from U.S. Pat. No. 4,688,329 and U.S. Pat. No. 5,007,168, and shaving apparatus with tiltable cutting units are known, for example, from U.S. Pat. No. 3,913,225 and U.S. Pat. No. 5,625,950.

It is an object of the invention to render the shaving head holder of the shaving apparatus mentioned in the opening paragraph depressible against the action of a spring in the operating condition, using simple means.

To achieve this, the shaving apparatus in accordance with the invention is characterized in that the shaving head holder in the second position can be depressed over a small distance against the action of said spring.

In this second position, wherein the shaving head holder is in a closed position with respect to the housing, which is the normal operating position for shaving, the shaving head holder can be depressed against the action of a spring when the shaving head holder is pressed against the skin. This causes the shaving head holder to pivot about its pivot pin.

Such a shaving head holder that can be depressed against the action of a spring can be realized in an embodiment which is characterized in that the latching means comprise a latching cam situated in the housing, which latching cam can be displaced against the action of a spring from a latched position to an unlatched position of the shaving head holder and, in the second position of the shaving head holder, said latching cam hooks behind a wall portion of the shaving head holder to latch the shaving head holder onto the housing, an edge portion of the shaving head holder being situated at some distance from an opposite edge portion of the housing, said shaving head holder being pivotably depressible over said distance. In the latched state, the shaving head holder is thus locked against rotation to the open position. Preferably, the latching means are situated at the edge of the housing opposite the pivot pin.

A further embodiment of the shaving apparatus in accordance with the invention is characterized in that the housing is provided with an upright wall portion the height of which is greater than the distance over which the shaving head holder can be depressed. As a result of this measure, in the second, closed position of the shaving head holder there is no gap between opposite edge portions of the shaving head holder and the housing. It is thus ensured that cut-off hair parts remain inside the hair chamber.

These and other aspects of the invention are apparent from and will be elucidated with reference to the embodiment(s) described hereinafter.

In the drawings:

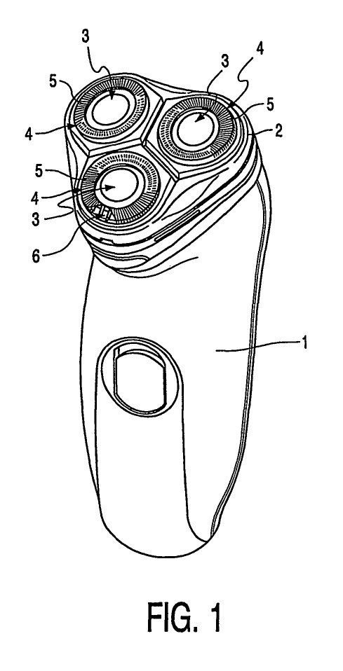

FIG. 1 is a perspective view of a shaving apparatus with a shaving head holder comprising three cutting units,

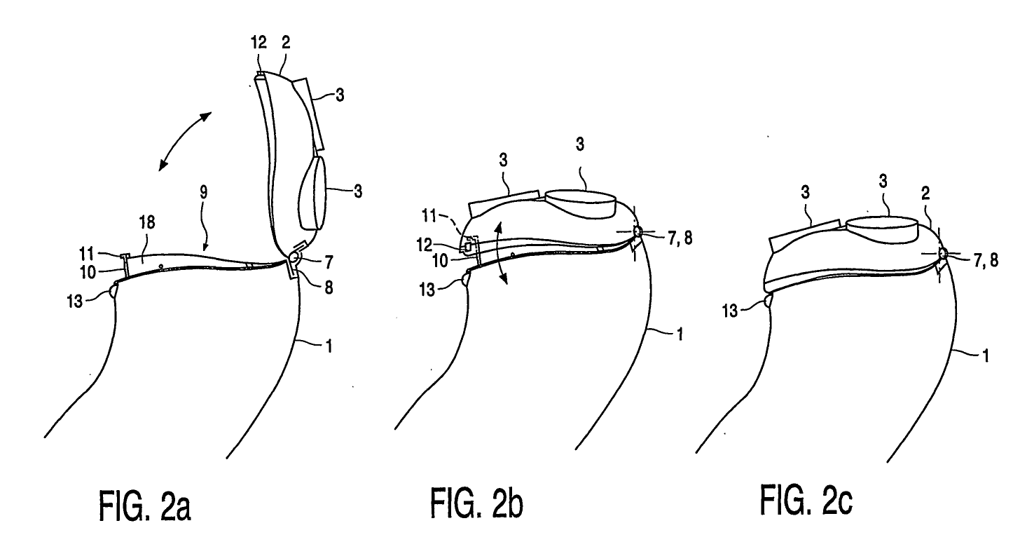

FIG. 2a shows the shaving apparatus of FIG. 1, the shaving head holder being in an open position with respect to the housing of the shaving apparatus,

FIG. 2b shows the shaving apparatus of FIG. 1, the shaving head holder being latched onto the housing in an undepressed position,

FIG. 2c shows the shaving apparatus of FIG. 2b, the shaving head holder being completely depressed, and

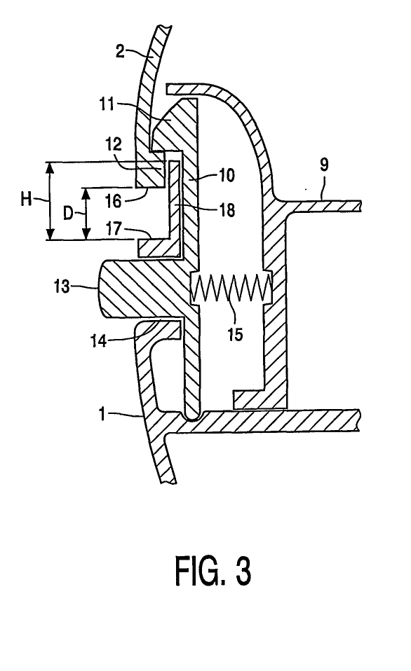

FIG. 3 is a cross-sectional view of the latching means for the shaving head holder.

FIG. 1 shows a rotary shaving apparatus comprising a housing 1 and a shaving head holder 2 that is pivotably connected to the housing. The shaving head holder accommodates three cutting units 3, also referred to as shaving heads, which each comprise an external cutting member 4 having hair-entry apertures 5 and an internal hair cutting member 6 which is rotatably drivable with respect to said external cutting member 4. The internal cutting members are driven in known manner by a motor (not shown) in the housing of the shaving apparatus.

In FIG. 2a, the shaving head holder 2 is shown in a first position wherein the holder is in an open position with respect to the housing 1. The shaving head holder 2 is connected to the housing 1 by means of a spring pivot. Said spring pivot has a pivot pin 7 with a coil spring 8, the end portions of which are clamped in the shaving head holder and in the housing. The spring force is such that the coil spring keeps the shaving head holder in the open position. In the open position, the hair chamber 9 situated between the shaving head holder 2 and the housing 1, and the cutting units can be cleaned.

In FIG. 2b, the shaving head holder 2 is shown in a second position wherein the holder is in a closed position with respect to the housing 1. Said closed position is obtained by pivoting the shaving head holder from the open position against the action of the coil spring 8. In the closed position, the shaving head holder is latched to the housing 1 by means of latching means. Said latching means are shown in FIG. 3 and include a latching arm 10 accommodated in the housing 1 and provided with a depressible, hook-shaped latching cam 11 and a wall portion 12 of the shaving head holder 2 co-operating therewith. The latching cam 11 is situated at one end of the arm 10, and the other end of the arm is pivotably accommodated in the housing. Between the ends of the arm there is an operating knob 13 that projects through an opening 14 of the housing 1. By means of said operating knob 13, the latching cam 11 can be displaced, against the action of the spring pressure exerted by a spring 15, from a latched position to an unlatched position of the shaving head holder 2. In the latched position, the latching cam 11 hooks behind the wall portion 12 of the shaving head holder, causing the latter to be latched to the housing 1 against the action of the coil spring 8, that is to say that the shaving head holder is prevented from pivoting to the open position. As shown in FIG. 3, an edge portion 16 of the shaving head holder 1 is at a distance D from an edge portion 17 of the housing 1. This is the distance over which the shaving head holder can be pivotably depressed relative to the housing against the action of the spring 8. In FIG. 2c the situation is shown wherein the shaving head holder is fully depressed and the edge portions 16 and 17 come into contact with each other. The housing 1 is further provided with an upright wall portion 18 (also see FIGS. 2a and 2b). The height H of this wall portion is greater than the distance D between the edge portions 16 and 17. The upright wall portion precludes that, in the closed operating position of the shaving head holder, cut-off hair parts can escape to the exterior by passing between the edge portions 16 and 17.

It will be clear that other latching means are also possible provided that, on the one hand, they preclude that in the second position, wherein the shaving head holder is in a closed position with respect to the housing and which is the normal operating position for shaving, the shaving head holder can pivot to the open, first position, and, on the other hand, that they enable the shaving head holder to be depressible against the action of a spring. It is for example possible to provide the operating knob 13 as a separate knob in a wall opening of the shaving head holder opposite the latching cam 11. By depressing such a knob, the latching cam 11 is pressed back and the shaving head holder is unlatched.

1. A shaving apparatus comprising a housing (1) and a shaving head holder (2) provided with at least one cutting unit (3) comprising an external cutting member (4) with hair-entry apertures (5) and an internal cutting member (6) which can be rotated with respect to said external cutting member, which shaving head holder (2) is connected to the housing (1) so as to be pivotable about a pivot pin (7), and can be pivoted from a first position, wherein the shaving head holder is in an open position with respect to the housing, against the action of a spring (8) to a second position wherein the shaving head holder is in a closed position with respect to the housing, and latching means (10, 11, 12, 13, 15) are present to latch the shaving head holder in the second position on the housing or to unlatch it from said housing, characterized in that the shaving head holder (2) in the second position can be depressed over a small distance (D) against the action of said spring (8).

2. A shaving apparatus as claimed in claim 1, characterized in that the latching means comprise a latching cam (11) situated in the housing, which latching cam can be displaced against the action of a spring from a latched position to an unlatched position of the shaving head holder (2) and, in the second position of the shaving head holder (2), said latching cam hooks behind a wall portion (12) of the shaving head holder to latch the shaving head holder on the housing, an edge portion (16) of the shaving head holder (2) being situated at a distance (D) from an opposite edge portion (7) of the housing (1), said shaving head holder (2) being pivotably depressible over said distance (D).

3. A shaving apparatus as claimed in claim 1, characterized in that the housing (1) is provided with an upright wall portion (18) the height (H) of which is greater than the distance (D) over which the shaving head holder (2) can be depressed.
